(19) United States
(12) Patent Application Publication
(10) Pub. No.: US 2008/0291806 A1
(43) Pub. Date: Nov. 27, 2008

(54) Optical Device for Recording and Reproducing Holographic Data

(75) Inventor: Marcello Leonardo Mario Balistreri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,717

(22) PCT Filed: May 9, 2005
(86) PCT No.: PCT/IB2005/051506

§ 371 Date: Nov. 6, 2006

(30) Foreign Application Priority Data
May 12, 2004 (EP) 04300272.4

(51) Int. Cl. G11B 7/00

(52) U.S. Cl. 369/103

(57) ABSTRACT

The invention relates to an optical recording and reproducing device. This device comprises means for receiving a recording medium (204), a radiation source (200) for producing a radiation beam, means (206) for detecting light corresponding to a holographic signal recorded in the recording medium, means (202) for directing the radiation beam towards the receiving means, and a reflective spatial light modulator (205) placed on the other side of the receiving means with respect to the detecting means.

### FIELD OF THE INVENTION

The present invention relates to an optical device for recording and reproducing data in and from a holographic recording medium.

The present invention is particularly relevant for a WORM (Write Once Read Many) holographic apparatus.

### BACKGROUND OF THE INVENTION

An optical device capable of recording on and reading from a holographic recording medium, with and without phase conjugate read out, is known from H. J. Coufal, D. Psaltis, G. T. Sincerbox (Eds.), ‘Holographic data storage’, Springer series in optical sciences, (2000). FIG. 1 shows such an optical device using phase conjugate read out. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113 and a detector 114. The optical device is intended to record in and read data from a recording medium 106.

During recording of a hologram in the recording medium, half of the radiation beam generated by the radiation source 100 is sent towards the spatial light modulator 103 by means of the first beam splitter 102. This portion of the radiation beam is called the signal beam. Half of the radiation beam generated by the radiation source 100 is deflected towards the telescope 108 by means of the first deflector 107. This portion of the radiation beam is called the reference beam. The signal beam is spatially modulated by means of the spatial light modulator 103. The spatial light modulator comprises transmissive areas and absorbent areas, which corresponds to zero and one data-bits of a hologram to be recorded. After the signal beam has passed through the spatial light modulator 103, it carries the signal to be recorded in the recording medium 106, i.e. the hologram to be recorded. The signal beam is then focused on the recording medium 106 by means of the lens 105.

The reference beam is also focused on the recording medium 106 by means of the first telescope 108. The hologram is thus recorded in the recording medium 106, in the form of an interference pattern as a result of interference between the signal beam and the reference beam. Once a hologram has been recorded in the recording medium 106, another hologram is recorded at a same location of the recording medium 106. To this end, data corresponding to this hologram are sent to the spatial light modulator. The first deflector 107 is rotated so that the angle of the reference signal with respect to the recording medium 106 is modified. The first telescope 108 is used to keep the reference beam at the same position while rotating. An interference pattern is thus recorded with a different pattern at a same location of the recording medium 106. This is called angle multiplexing. A same location of the recording medium 106 where a plurality of holograms is recorded is called a book.

Alternatively, the wavelength of the radiation beam may be tuned in order to record different holograms in a same book. This is called wavelength multiplexing.

During readout of a hologram from the recording medium, the spatial light modulator 103 is made completely absorbent, so that no portion of the beam can pass trough the spatial light modulator 103. The first deflector 107 is removed, such that the portion of the beam generated by the radiation source 100 that passes through the beam splitter 102 reaches the second deflector 112 via the first mirror 109, the half wave plate 110 and the second mirror 111. If angle multiplexing has been used for recording the holograms in the recording medium 106, and a given hologram is to be read out, the second deflector 112 is arranged in such a way that its angle with respect to the recording medium 106 is the same as the angle that were used for recording this given hologram. The signal that is deflected by the second deflector 112 and focused in the recording medium 106 by means of the second telescope 113 is thus the phase conjugate of the reference signal that were used for recording this given hologram. If wavelength multiplexing has been used for recording the holograms in the recording medium 106, and a given hologram is to be read out, the same wavelength is used for reading this given hologram.

The phase conjugate of the reference signal is then diffracted by the information pattern, which creates a reconstructed signal beam, which then reaches the detector 114 via the lens 105 and the second beam splitter 104.

A drawback of this WORM holographic apparatus is that it requires an optical branch for generating the reference signal and another optical branch for generating the phase conjugate of the reference signal. This makes such a holographic apparatus bulky and expensive, and makes the manufacture of such a holographic apparatus long and complicated.

### SUMMARY OF THE INVENTION

It is an object of the invention to provide a WORM holographic apparatus which is more compact and easier to manufacture.

To this end, the invention proposes an optical recording and reproducing device comprising means for receiving a recording medium, a radiation source for producing a radiation beam, means for detecting light corresponding to a holographic signal recorded in said recording medium, means for directing said radiation beam towards said receiving means, and a reflective spatial light modulator placed on the other side of the receiving means with respect to the detecting means.

According to the invention, a reflective spatial light modulator is used. During recording, the radiation beam is directed towards the recording medium, then spatially modulated and reflected back towards the recording medium. As a consequence, a reference beam and a signal beam interfere inside the recording medium, which creates an information pattern inside said recording medium. During read out, the reference beam is directed towards the recording medium, then diffracted by the information pattern towards the detecting means. The WORM holographic apparatus in accordance with the invention thus does not require separate optical branches for generating the signal beam and the reference beam. It is thus relatively compact and easy to manufacture.

Advantageously, the directing means comprise a polarizing beam splitter between the detecting means and the receiving means and a quarter wave plate between the polarizing beam splitter and the receiving means. This solution is particularly easy to implement and ensure that the same optical elements are used during recording and read-out.

Preferably, the radiation beam has a wavelength which can be tuned for recording different holograms at a same location of the recording medium. This allows for wavelength multiplexing, which increases the data capacity that can be recorded in the recording medium.

Advantageously, the optical recording and reproducing device further comprises a first lens between the directing means and the receiving means and a second lens between the receiving means and the reflective spatial light modulator. The size of the recorded hologram reduces due to the use of the lens, which increases the data capacity that can be recorded in the recording medium. Furthermore, the use of the lenses allows interference of spherical waves inside the recording medium. As a consequence, shift multiplexing is possible, which increases the data capacity further. These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows an optical device in accordance with the prior art;

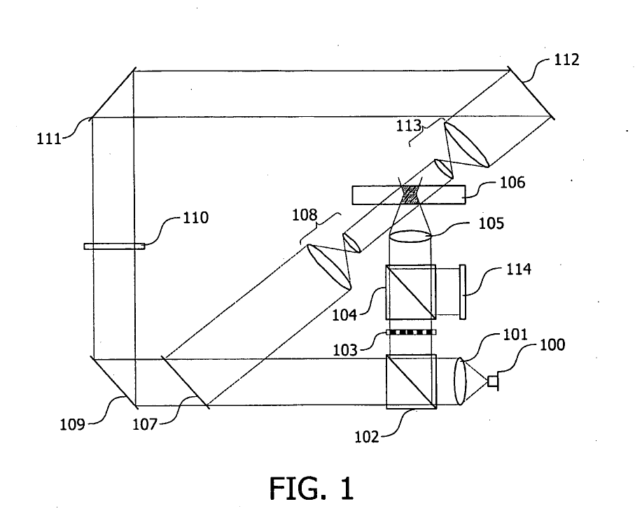

FIGS. 2a and 2b show an optical device in accordance with the invention during recording and read-out respectively;

FIGS. 3a and 3b show an optical device in accordance with an advantageous embodiment of the invention during recording and read-out respectively.

### DETAILED DESCRIPTION OF THE INVENTION

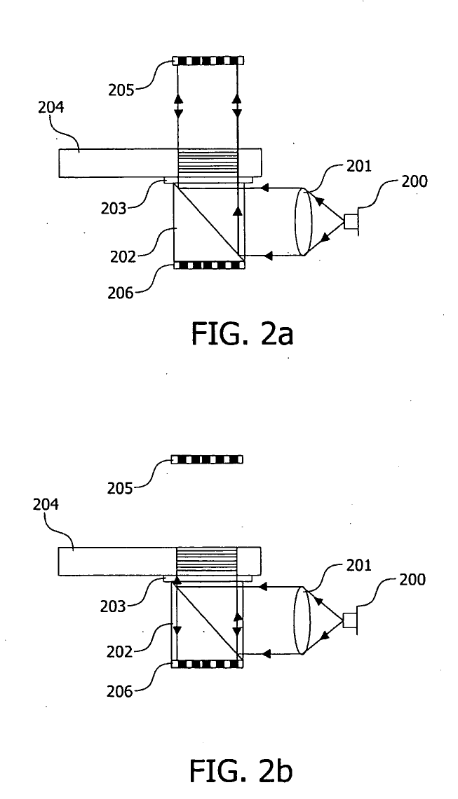

An optical device in accordance with the invention is depicted in FIGS. 2a and 2b. This optical device comprises a radiation source 200, a collimator 201, a polarizing beam splitter 202, a quarter wave plate 203, a reflective spatial light modulator 205 and detecting means 206. This optical device is intended to record in and read holographic data from a recording medium 204. The optical device also comprises means for receiving the recording medium, which are not shown in FIGS. 2a and 2b. These receiving means are, for example, a table on which the recording medium can be put. A table such as those conventionally used in CD or DVD players can be used for example.

During recording, which is represented in FIG. 2a, the radiation source 200 generates a radiation beam, which is transformed into a parallel beam by means of the collimator 201. This parallel beam is then directed towards the recording medium by means of the polarizing beam splitter 202. After the parallel beam has passed through the polarizing beam splitter 202, it has a linear polarization. This linearly polarized beam then passes through the quarter wave plate 203, which creates a circularly polarized beam. This latter beam passes through the recording medium 204 and reaches the reflective spatial light modulator 205. A reflected signal is thus reflected, which is circularly polarized and carries the information sent to the reflective spatial light modulator 205. This reflected signal then reaches the recording medium 204, where interference takes place with the circularly polarized beam that has just passed through the quarter wave plate 203. This interference creates an information pattern in the recording medium 204, and the hologram to be recorded is thus recorded. Interference can take place between the beam coming from the reflective spatial light modulator 205 and the beam that has just passed through the quarter wave plate 203, because these two beams have the same polarization. The beam that has just passed through the quarter wave plate 203 plays the role of a reference beam, whereas the beam coming from the reflective spatial light modulator 205 plays the role of a signal beam.

In the optical device in accordance with the invention, the signal beam and the reference beam thus are generated with the same optical branch, which comprises the directing means and the reflective spatial light modulator 205. As a consequence, the optical device in accordance with the invention is much more compact than the optical device in accordance with the prior art.

The reflective spatial light modulator 205 may be, for example, a reflective ferroelectric Liquid Crystal on Silicon (FLCOS) spatial light modulator. Such a spatial light modulator is commercialized, inter alia, by the companies “Boulder Nonlinear Systems” and “Displaytech”. The reflective spatial light modulator 205 may also be a reflective Digital Micromirror Device (DMD) spatial light modulator. Such a spatial light modulator is commercialized, inter alia, by the company “Productivity Systems”. The reflective spatial light modulator 205 may also be a combination of a transmissive spatial light modulator and a mirror, although this solution is less preferred, because the efficiency of a transmissive spatial light modulator is lower than the efficiency of a reflective spatial light modulator.

Once a hologram has been recorded, another hologram may be recorded by modifying the wavelength of the radiation beam. The optical device in accordance with the invention is particularly advantageous for wavelength multiplexing. Actually, in order to record a relatively high number of holograms in a same book of the recording medium 204, the wavelength selectivity should be as low as possible. The wavelength selectivity represents the gap between two successive wavelengths that can be used for recording two holograms with acceptable crosstalk. It is known from H. J. Coufal, D. Psaltis, G. T. Sincerbox (Eds.), ‘Holographic data storage’, Springer series in optical sciences, (2000) that the wavelength selectivity is: Δλ=(λ² cos θₛ)/2L sin² [0.5(θᵣ+θₛ)], where λ is the wavelength, L the thickness of the medium, θᵣ and θₛ the angles between the reference beam and the signal beam with the normal of the medium, respectively. In the optical device of the prior art, the angle θᵣ between the reference beam and the normal of the medium is about π/4, whereas this angle is null in the optical device in accordance with the invention. It can be calculated that the wavelength selectivity is about 6.8 times better in the optical device in accordance with the invention than in the optical device of the prior art.

This means that the number of holograms that can be recorded per book is about 6.8 times higher in the optical device in accordance with the invention than in the optical device of the prior art. As a consequence, the data capacity is increased when a WORM holographic apparatus in accordance with the invention is used.

Once a book has been recorded in the recording medium 204, another book may be recorded by moving the recording medium 204 with respect to the optical pick-up unit comprising the detecting means 206, the polarizing beam splitter 202, the quarter wave plate 203 and the reflective spatial light modulator 205. Alternatively, the optical pick-up unit is moved with respect to the recording medium 204, in a direction parallel to the recording medium 204.

During read-out, which is represented in FIG. 2b, the radiation source 200 generates a radiation beam having a given wavelength, which is transformed into a parallel beam by means of the collimator 201. This parallel beam is then directed towards the recording medium by means of the polarizing beam splitter 202. After the parallel beam has passed through the polarizing beam splitter 202, it has a linear polarization. This linearly polarized beam then passes through the quarter wave plate 203, which creates a circularly polarized beam. This latter beam reaches the recording medium 204, and is reflected by the information pattern recorded in said recording medium 204. A reconstructed signal beam is thus created, which carries the recorded information corresponding to the hologram recorded with the same wavelength. This reconstructed signal beam passes through the quarter wave plate 203, which creates a linearly polarized beam, which polarization is perpendicular to the polarization of the beam that has just been deflected by the polarizing beam splitter. As a consequence, this linearly polarized reconstructed signal beam passes through the polarizing beam splitter and thus reaches the detecting means 206. The recorded hologram is thus read-out. In order to read out another hologram, the wavelength of the radiation beam generated by the radiation source 200 is modified.

The detecting means 206 are for example a CMOS pixel detector array, or a CCD array.

It should be noted, that the medium 204 has to be switched after recording, in such a way that the side of the recording medium 204 that faces the spatial light modulator during recording faces the detecting means during read-out, before it can be read out in order to obtain a real image. Without switching the medium a virtual image would be obtained which cannot be detected by the detecting means. Advantageously, the optical device in accordance with the invention comprises means for automatically rotating said recording medium 204 when needed.

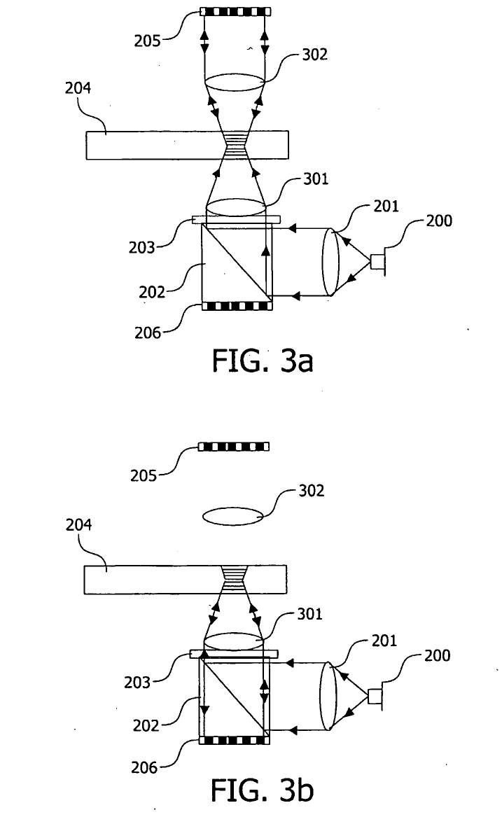

FIGS. 3a and 3b show an optical device in accordance with an advantageous embodiment of the invention. This optical device comprises, in addition to elements already depicted with reference to FIGS. 2a and 2b, a first lens 301 and a second lens 302. The first lens 301 is arranged between the polarizing beam splitter and the recording medium, and the second lens 302 is arranged between the recording medium 204 and the reflective spatial light modulator 205.

During recording, which is represented in FIG. 3a, the radiation beam that has passed through the quarter wave plate 203 is focused in the recording medium 204 by means of the first lens 301. A spherical wave beam is thus focussed in the recording medium 204. This spherical wave beam is then made parallel by means of the second lens 302, and then reaches the reflective spatial light modulator 205 where a signal beam is created. On the way back from the spatial light modulator 205, the signal beam is focused on the recording medium 204 by means of the second lens 302. As a consequence, a spherical wave signal beam interferes with a spherical wave reference beam inside the recording medium 204, and an information pattern is created, which corresponds to the hologram to be recorded.

The fact that spherical waves beams interfere inside the recording medium 204 allows for shift multiplexing. Shift multiplexing consists in recording a set of holograms by shifting the recording medium with respect to the optical pick-up unit. Once a hologram or a book has been recorded at a given location of the recording medium, the recording medium is moved over a distance that is less that the width of a hologram. Shift multiplexing is only possible when spherical waves interfere, and would thus not be possible with the optical device of FIGS. 2a and 2b.

Advantageously, a combination of shift multiplexing and wavelength multiplexing is used for recording data in the recording medium 204. For example, a book is recorded at a certain location by tuning the wavelength of the radiation beam generated by the radiation source 200. Once this book has been recorded, the recording medium 204 is shifted with respect to the optical pick-up unit, over a distance that is smaller than the width of a book. Another book is then recorded by tuning the wavelength of the radiation beam.

It should be noted that the first and the second lens 301 and 302 may have a relatively low numerical aperture, such as 0.4. Actually, these lenses are only used for producing spherical waves. As a consequence, the use of such low numerical aperture, and thus cheap, lenses, makes the price of the optical device relatively low.

It should also be noted that the quarter wave plate 203 could be placed between the first lens 301 and the recording medium 204, although this solution is less preferred, because the efficacy of a quarter wave plate is better in a parallel beam than in a convergent beam.

During read-out, which is represented in FIG. 3b, a spherical wave beam is sent towards the recording medium 204 and is reflected by the information pattern. As explained in FIG. 2b, a reconstructed signal beam is created, which then reaches the detecting means 206. Read-out of a hologram that has been recorded with a given wavelength and a given position of the recording medium 204 with respect to the optical pick-up unit is performed by placing the recording medium 204 at the same position and generating a radiation beam having the same wavelength. It should be noted, that the medium 204 needs not to be switched after recording before it can be read out. A real image is obtained without switching the medium 204 because the virtual image is converted into a real image by the first lens 301.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical recording and reproducing device comprising means for receiving a recording medium (204), a radiation source (200) for producing a radiation beam, means (206) for detecting light corresponding to a holographic signal recorded in said recording medium, means (202) for directing said radiation beam towards said receiving means, and a reflective spatial light modulator (205) placed on the other side of the receiving means with respect to the detecting means.

2. An optical recording and reproducing device as claimed in claim 1, wherein said directing means comprise a polarizing beam splitter (202) between the detecting means and the receiving means and a quarter wave plate (203) between the polarizing beam splitter and the receiving means.

3. An optical recording and reproducing device as claimed in claim 1, wherein said radiation beam has a wavelength which can be tuned for recording different holograms at a same location of the recording medium.

4. An optical recording and reproducing device as claimed in claim 1, further comprising a first lens (301) between the detecting means and the receiving means and a second lens (302) between the receiving means and the reflective spatial light modulator.
